(19) United States
(12) Patent Application Publication
(10) Pub. No.: US 2024/0283642 A1
(43) Pub. Date: Aug. 22, 2024

(54) SYSTEM AND METHOD FOR SECURE TRANSFER OF BIOMETRIC TEMPLATES BETWEEN BIOMETRIC DEVICE

(71) Applicant: THALES DIS USA, INC., Austin, TX (US)

(72) Inventors: Michael HUTCHINSON, Cedar Park, TX (US); Ramandeep SINGH, Pradesh (IN)

(73) Assignee: THALES DIS USA, INC., Austin, TX (US)

(21) Appl. No.: 17/889,526

(22) Filed: Feb. 22, 2023

(51) Int. Cl. H04L 9/08

(52) U.S. Cl. CPC H04L 9/0866; H04L 9/0819

(57) ABSTRACT

A system or method of authenticating a biometrically protected device without prior enrollment on that device can include one or more processors and memory where the memory includes computer instructions which when executed by the one or more processors causes the one or more processors to perform the operations of receiving a biometric reading, obtaining an encrypted biometric template from a server if a biometric template is not locally stored on a biometrically protected device to compare with the biometric reading, decrypting the encrypted biometric template from the server in response to a password to provide a decrypted biometric template, storing the decrypted biometric template locally on the biometrically protected device, and authenticating the biometric reading when the decrypted biometric template matches the biometric reading. The encrypted biometric template was previously uploaded to the server via an alternate biometric device.

### CROSS-REFERENCE TO RELATED APPLICATIONS

Not applicable.

### TECHNICAL FIELD

The present disclosure generally relates to authentication of communication devices. More particularly, but not exclusively, the present disclosure relates to authentication of communication devices using biometric templates.

### BACKGROUND

Traditional PKI models for securing devices and messages between ever-increasing multitudes of devices fail to be scalable and secure in terms of privacy. Although point-to-point encryption can provide authentication and digital certificates can provide a safe environment for IoT devices to function, there is still opportunity for data leakage and hacking with existing PKI schemes, particularly when biometric readings are used for authentication. PKI is a core component of TLS (Transport Layer Security), and implementing it into IoT brings much-needed standardization and security, but more can be done to make a PKI based system scalable and secure.

Between client and server devices, PKI systems use a TLS handshake, where both client and server exchange their certificates in the clear. In other words, the exchange done during a traditional TLS handshake makes it possible to track the device activity each time a connection is established. When doing biometric verification, there is also a concern about storage and management of a user's biometric template data. Even if the biometric template data is encrypted, there are issues in managing associated keys and there will always be a risk of key compromise.

Existing techniques for authenticating a number of biometric devices typically requires enrollment for each device, which is a cumbersome process since extensive time is needed to repeat enrollment with each new device with poor user interfaces. Furthermore, a change of biometric source needs re-enrollment on each device. Other techniques use enrollments stored on server but matched on the device or enrollments stored on the server in plain text. Such schemes have exposure to elicit duplication. Yet other schemes have enrollments stored and matched on a server where verifications are sent to the server for matching. Again, such schemes have exposure to elicit duplication.

Existing systems have been designed for providing secure user authentication over a network using biometric sensors. In particular, an Online Secure Transaction Plugin (OSTP) protocol developed by the Fast Identify Online (FIDO) alliance enables strong authentication (e.g., protection against identity theft and phishing), secure transactions (e.g., protection against “malware in the browser” and “man in the middle” attacks for transactions), and enrollment/management of client authentication tokens (e.g., fingerprint readers, facial recognition devices, smartcards, trusted platform modules, etc). Details of the existing OSTP protocol can be found, for example, in U.S. Patent Application No. 2011/0082801 (“801 application”), and the document entitled OSTP Framework (Mar. 23, 2011), both of which describe a framework for user registration and authentication on a network.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### SUMMARY

In some embodiments, a method of authenticating a biometric device without prior enrollment can include one or more processors and memory coupled to the one or more processors where the memory includes computer instructions which when executed by the one or more processors causes the one or more processors to perform the operations of receiving a biometric reading, obtaining an encrypted biometric template from a server if a biometric template is not locally stored on a biometrically protected device to compare with the biometric reading, decrypting the encrypted biometric template from the server in response to a user inputted password to provide a decrypted biometric template, storing the decrypted biometric template locally on the biometrically protected device, and authenticating the biometric reading when the decrypted biometric template matches the biometric reading.

In some embodiments, the method further includes converting the biometric reading to a template of the biometric reading and the step of authenticating includes comparing the template of the biometric reading with the decrypted biometric template. In some embodiments, the method further determines if a biometric template is already stored locally on the biometrically protected device. In some embodiments, the biometric reading is authenticated without obtaining the encrypted biometric template from the server when the biometric template is already stored locally on the biometrically protected device and the biometric template matches the biometric reading.

In some embodiments, the method further includes performing a new enrollment of the biometrically protected device when a biometric template is neither stored locally on the biometrically protected device nor as an encrypted biometric template on the server. The step of performing the new enrollment can include converting the biometric reading to a template of the biometric reading, storing the template of the biometric reading on the biometrically protected device, encrypting the template of the biometric reading to provide an encrypted biometric template, and uploading the encrypted biometric template to the server for storage.

In some embodiments, the step of performing the new enrollment includes converting the biometric reading to a template of the biometric reading, receiving a password to generate a key, using the key to encrypt the template of the biometric reading to provide an encrypted biometric template, and uploading the encrypted biometric template to the server for storage

In some embodiments, the step of performing the new enrollment comprises converting the biometric reading to a template of the biometric reading, receiving a password to generate a key, using the key to encrypt the template of the biometric reading to provide an encrypted biometric template, deleting the password and key, and uploading the encrypted biometric template to the server for storage at the server.

In some embodiments, method further comprises the step of performing a new enrollment of the biometrically protected device when a biometric template is neither stored locally on the biometrically protected device nor as an encrypted biometric template on the server by converting the biometric reading to a template of the biometric reading, storing the template of the biometric reading on the biometrically protected device, receiving a password to generate a key, encrypting the template of the biometric reading using the key to provide an encrypted biometric template, deleting the password and key, and uploading the encrypted biometric template to the server for storage.

In some embodiments, the encrypted biometric template uses a password based key derivation function (such as PBKDF2) to prompt a user to enter a secret password that is used to generate a key for encrypting the encrypted biometric template.

In some embodiments, a method of authenticating biometric device without prior enrollment of the biometric device includes one or more processors and memory coupled to the one or more processors, where the memory includes computer instructions which when executed by the one or more processors causes the one or more processors to perform the operations of receiving a biometric reading, converting the biometric reading into biometric template data, comparing the biometric template data with a biometric template locally stored when the biometric template is locally stored on a biometrically protected device that received the biometric reading and authenticating the biometric reading if the biometric template data matches the biometric template locally stored, obtaining an encrypted biometric template from a server if the biometric template is not locally stored on the biometrically protected device to compare with the biometric template data, decrypting the encrypted biometric template from the server in response to receiving a password to provide a decrypted biometric template, storing the decrypted biometric template locally on the biometrically protected device, and authenticating the biometric reading when the decrypted biometric template matches the biometric template data.

In some embodiments, the method further includes the step of performing a new enrollment of the biometrically protected device when a biometric template is neither stored locally on the biometrically protected device nor as an encrypted biometric template on the server. In some embodiments, the step of performing the new enrollment includes converting the biometric reading to a template of the biometric reading, storing the template of the biometric reading on the biometrically protected device, encrypting the template of the biometric reading to provide an encrypted biometric template, and uploading the encrypted biometric template to the server for storage.

In some embodiments, the step of performing the new enrollment includes converting the biometric reading to a template of the biometric reading, receiving a password to generate a key, using the key to encrypt the template of the biometric reading to provide an encrypted biometric template, and uploading the encrypted biometric template to the server for storage.

In some embodiments, the step of performing the new enrollment includes converting the biometric reading to a template of the biometric reading, receiving a password to generate a key, using the key to encrypt the template of the biometric reading to provide an encrypted biometric template, deleting the password and key, and uploading the encrypted biometric template to the server for storage at the server.

In some embodiments, the method further includes the step of performing a new enrollment of the biometrically protected device when a biometric template is neither stored locally on the biometrically protected device nor as an encrypted biometric template on the server by converting the biometric reading to a template of the biometric reading, storing the template of the biometric reading on the biometrically protected device, receiving a password to generate a key, encrypting the template of the biometric reading using the key to provide an encrypted biometric template, deleting the password and key, and uploading the encrypted biometric template to the server for storage at the server.

In some embodiment, the encrypted biometric template uses a password based key derivation function to prompt a user to enter a secret password that is used to generate a key for encrypting the encrypted biometric template.

In some embodiments, a system of authenticating biometric devices without having to re-enroll each new biometric device includes one or more processors and memory coupled to the one or more processors, wherein the memory includes computer instructions which when executed by the one or more processors causes the one or more processors to perform the operations of receiving a biometric reading, receiving an encrypted biometric template from a server if a biometric template is not locally stored on a biometrically protected device to compare with the biometric reading, decrypting the encrypted biometric template from the server in response to receiving a password to provide a decrypted biometric template, storing the decrypted biometric template locally on the biometrically protected device, and authenticating the biometric reading when the decrypted biometric template matches the biometric reading.

In some embodiments, a system of authenticating a secondary biometrically protected device without prior enrollment of the biometric when the biometrically protected device receives a biometric reading, converts the biometric reading into biometric template data and fails to find a locally stored biometric template for comparison but does find an encrypted biometric template on the server, such system includes one or more processors and memory coupled to the one or more processors, wherein the memory includes computer instructions which when executed by the one or more processors causes the one or more processors to perform the operations at a server of downloading the encrypted biometric template from the server. In such a system, the encrypted biometric template was previously created by performing a new enrollment of the primary biometrically protected device when a biometric template was neither stored locally on the primary biometrically protected device nor as an encrypted biometric template on the server.

In some embodiments, the step of performing the new enrollment of the biometrically protected device when the biometric template is neither stored locally on the biometrically protected device nor as an encrypted biometric template on the server is done by uploading the encrypted biometric template from the biometrically protected device for storage at the server after the biometrically protected device converts the biometric reading to a template of the biometric reading, stores the template of the biometric reading on the biometrically protected device, receives a password to generate a key, encrypts the template of the biometric reading using the key to provide the encrypted biometric template, and deletes the password and key from the biometrically protected device before uploading the encrypted biometric template to the server.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 illustrates a system of authenticating biometric devices without having to re-enroll each new biometric device in accordance with the embodiments;

FIG. 2 illustrates a flow chart of a method of authenticating biometric devices without having to re-enroll each new biometric device in accordance with the embodiments; and

FIG. 3 illustrates a flow chart of a method of new enrollment as part of a method of authenticating biometric devices without having to re-enroll each new biometric device in accordance with the embodiments.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

These embodiments concern “Match on device” biometrics authentications from multiple devices that currently requires enrollment on each individual device. Using the claimed embodiments obviates the need for enrollment on each device with a way to securely transfer biometrics between the end user's devices.

The claimed embodiments allow a user to utilize their biometrics on multiple devices without having to re-enroll their biometrics on each device while still preserving the privacy and integrity of their biometric data. In some embodiments, a transfer/backup service or server stores the biometric template encrypted with a key generated from end user entered data.

When doing biometrics verification there is always a concern about storage and management of a user's biometrics template data. Even if the biometrics template data is encrypted there are issues in managing the associated keys and a risk of key compromise. There are also user privacy concerns if the central authority that is storing and encrypting the biometric template data is also in the procession of the encryption keys. Also, if the user wants to access the same service from multiple devices they need to re-enroll their biometrics again on each device. Accordingly, the embodiments described herein provide for a secure way to utilize the same key to encrypt and decrypt the biometrics on the end user's devices. If the user were to use their biometrics on different devices they need to encrypt the biometric template data stored locally on the new device using a new key posing new challenges to manage multiple keys and doing enrollment every time using a new device.

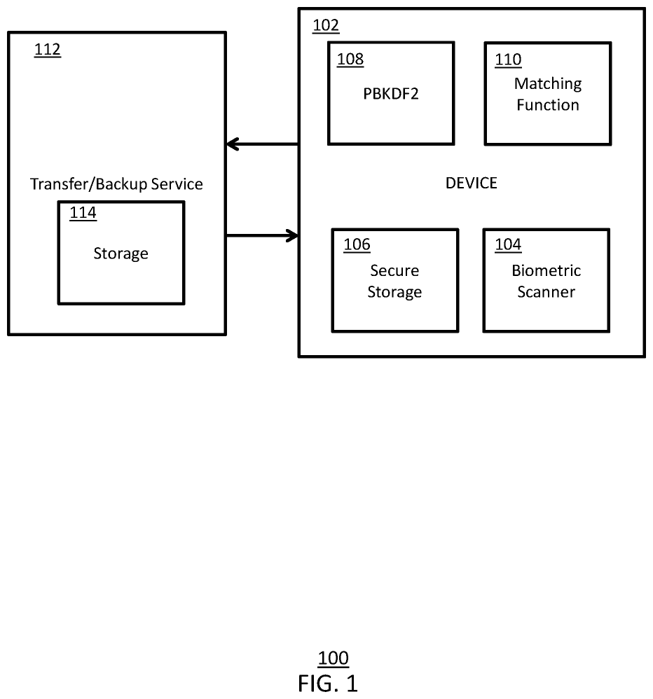

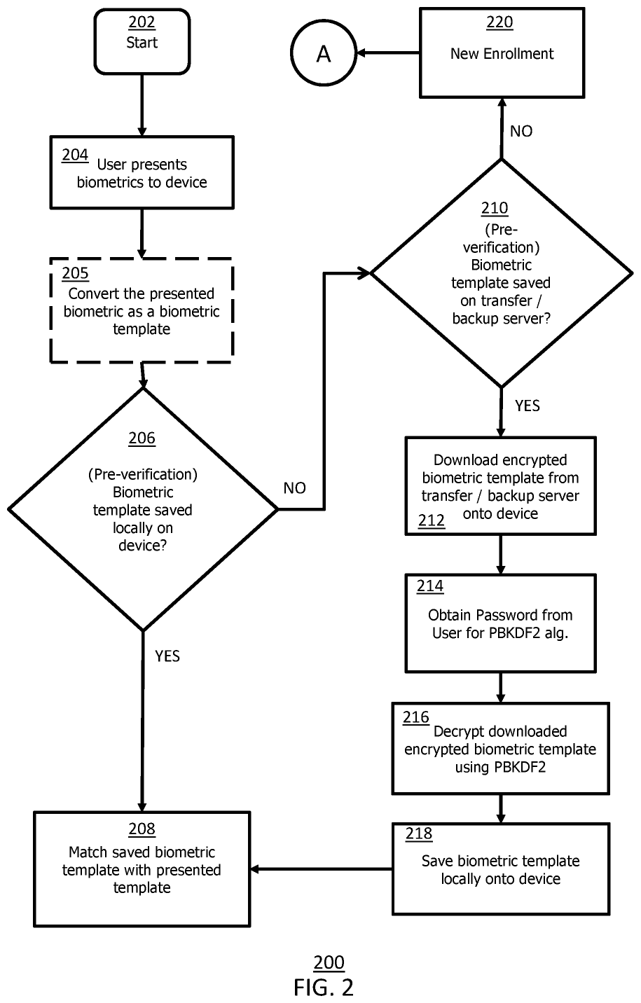

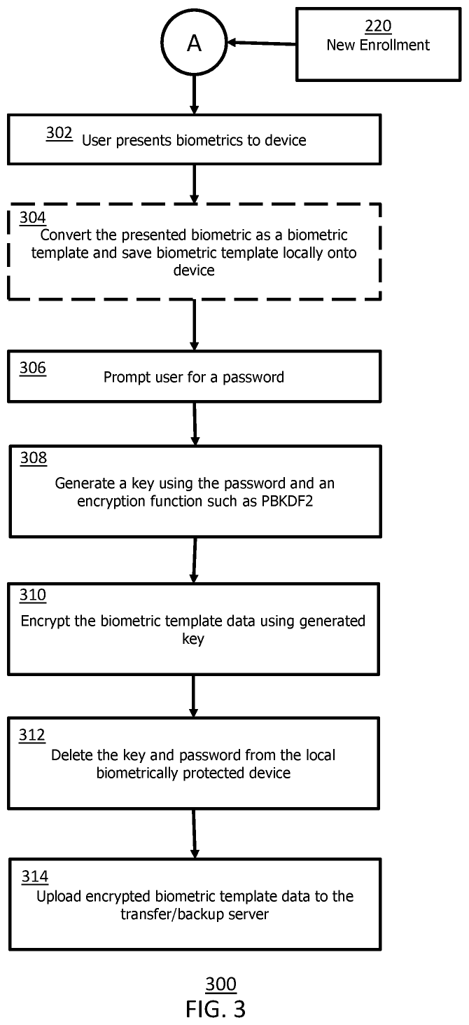

The embodiments herein resolve the issue described above in a unique way by securing and transferring the biometric template data from one device to another. From a system view as illustrated by system 100 in FIG. 1, the solution can include a plurality of biometrically protected devices such as a client device 102 having a biometric scanner 104 that can capture a user's biometric input or a biometric reading. If a biometric template is not locally stored (such as in secure storage 106) on the biometrically protected device 102 to compare with the biometric reading, then the device obtains or receives an encrypted biometric template from a server or transfer/backup service 112 from its storage 114. The device 102 can decrypt the encrypted biometric template from the server 112 using a password that generates a key to provide a decrypted biometric template. The decryption can be done using a password based key derivation function 108 such as PBKDF2. The decrypted biometric template is compared with a biometric template derived from the biometric reading done by the biometric scanner 104. A matching function 110 compares the biometric templates and authenticates the user and communication session upon determining a match. In some embodiments, a solution can also include and be divided into 3 stages, namely a pre-verification stage, an enrollment stage, and a verification stage. With reference to the flow charts of FIGS. 2 and 3 illustrating the methods 200 and 300, the pre-verification stage can be represented by blocks 202, 204, 205, 206, and 210, the enrollment stage by blocks 220 and 302 through 314, and the verification stage by blocks 212, 214, 216, 218, and 208.

### Pre-Verification Stage

In this stage the device must determine if it already has biometric template data available (at 206 or 210) or needs to perform an enrollment (at 220 and 302-314) using the biometric scanner. It first checks if it has existing biometric template data available within its own secure storage at 206. If it does not have the template then it then checks if it has encrypted biometric template data stored within the transfer/backup service provider at 210.

If there is an existing biometric template data then it enters the “verification stage” at 208.

If there is no existing biometric template data then it enters the “enrollment stage” at 220 and 302-313.

### Enrollment Stage

When a user wants to access a service, such as an online service provider, that requires authentication protected by a biometric verification, they need to first enroll their biometrics with the device at 220 as shown in FIG. 2 or FIG. 3. This stage is known as the “enrollment stage”.

In this stage, the user presents their biometric at 302 to the biometrics scanning device, e.g. their mobile phone. In order to preserve or prevent the scanned data from direct capture the scanned user biometrics is converted into biometric template data at 304. The biometric template data is then stored within the device for future verifications 304.

In order to prevent off device access to the biometric template data it is encrypted. Encryption is done by prompting the user to enter a secret pin or password at 306. This secret password can be any value that the user can successfully remember. The secret password is used to generate a key at 308 using a password based key derivation function (e.g. PBKDF2). This key is used to encrypt at 310 the biometric template data created during enrollment. After the encryption the secret password and the derived key are discarded or deleted at 312 from the memory of the device and thus not stored anywhere during the entire lifecycle of biometric template data, the encrypted biometric template data can be uploaded at 314 to the transfer/backup service.

### Verification Stage

When the user tries to access the same service again they are prompted to provide their biometrics for verification. User presents their biometrics using the mobile device biometrics scanner (at 204).

If the user is in possession of the same device as used during registration then the verification proceeds as normal (at 208), however if the device is a different one then in order to complete the verification the device must request the encrypted biometric template data from the transfer/backup service provider at decision block 210.

The encrypted biometric template data that was uploaded, during the enrollment stage, to the transfer/backup service provider is downloaded to the device at 212. Upon receiving the encrypted biometric template data on the user's device the user will be prompted to enter the secret password at 214. When the user enters the secret password the same password based key derivation function that was used during enrollment (e.g PBKDF2) is invoked to derive a key. This key will then be used to decrypt at 216 the biometric template data where the decrypted biometric template is stored locally at 218. If the decrypted biometrics are matched with the one that user presented during the verification stage a match will be found at 208. This matching is always done on the device itself. A successful match allows the authentication to proceed for the service indicating that the user was successfully authenticated. User will then be allowed to access the service. The biometric template data will be stored on the device as if it had been enrolled using the “enrollment stage”. Future verifications will not need to communicate with the transfer/backup service provider as the decrypted biometric template data will be already stored ready for comparison to any new biometric readings for the same user.

In this solution the transfer/backup service provider has no access to the direct user biometric data or the biometric template data version as all the stored data is encrypted. The user has full control to their private biometric data, thus satisfying the user's privacy and standards compliance (e.g. GDPR) or other data privacy compliance.

The embodiments herein enable a user to use their biometrics on multiple devices without having to re-enroll their biometrics on each device while preserving the privacy and integrity of the biometric data.

Such enabled devices can win the trust of their users regarding the privacy of their biometrics data also enables users to use their biometrics on multiple devices securely. Such a scheme can be used on a wide variety of devices and systems including, for example, SafeNet Trusted Access (IAM), Digital ID (government program), or ID Cloud (digital banking).

In the absence of any specific clarification related to its express use in a particular context, where the terms “substantial” or “about” or “usually” in any grammatical form are used as modifiers in the present disclosure and any appended claims (e.g., to modify a structure, a dimension, a measurement, or some other characteristic), it is understood that the characteristic may vary by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device or processor may be transformed from a generic and unspecific computing device or processor to a combination device comprising hardware and software configured for a specific and particular purpose providing more than conventional functions and solving a particular technical problem with a particular technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and Abstract of the Disclosure provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide further embodiments.

1. A method of authenticating a biometric device without prior enrollment on that biometric device, comprising:
one or more processors and memory coupled to the one or more processors, wherein the memory includes computer instructions which when executed by the one or more processors causes the one or more processors to perform the operations of:
receiving a biometric reading;
obtaining an encrypted biometric template from a server if a biometric template is not locally stored on a biometrically protected device to compare with the biometric reading;
decrypting the encrypted biometric template from the server in response to a user provided password to obtain a decrypted biometric template;
storing the decrypted biometric template locally on the biometrically protected device; and
authenticating the biometric reading when the decrypted biometric template matches the biometric reading.

2. The method of claim 1, wherein the method further comprises converting the biometric reading to a template of the biometric reading and the step of authenticating comprises comparing the template of the biometric reading with the decrypted biometric template.

3. The method of claim 1, wherein the method further determines if a biometric template is already stored locally on the biometrically protected device.

4. The method of claim 3, wherein the biometric reading is authenticated without obtaining the encrypted biometric template from the server when the biometric template is already stored locally on the biometrically protected device and the biometric template matches the biometric reading.

5. The method of claim 1, wherein the method further comprises the step of performing a new enrollment of the biometrically protected device when a biometric template is neither stored locally on the biometrically protected device nor as an encrypted biometric template on the server.

6. The method of claim 5, wherein the step of performing the new enrollment comprises converting the biometric reading to a template of the biometric reading, storing the template of the biometric reading on the biometrically protected device, encrypting the template of the biometric reading to provide an encrypted biometric template, and uploading the encrypted biometric template to the server for storage.

7. The method of claim 5, wherein the step of performing the new enrollment comprises converting the biometric reading to a template of the biometric reading, receiving a password to generate a key, using the key to encrypt the template of the biometric reading to provide an encrypted biometric template, and uploading the encrypted biometric template to the server for storage

8. The method of claim 5, wherein the step of performing the new enrollment comprises converting the biometric reading to a template of the biometric reading, receiving a password to generate a key, using the key to encrypt the template of the biometric reading to provide an encrypted biometric template, deleting the password and key, and uploading the encrypted biometric template to the server for storage at the server.

9. The method of claim 1, wherein the method further comprises the step of performing a new enrollment of the biometrically protected device when a biometric template is neither stored locally on the biometrically protected device nor as an encrypted biometric template on the server by converting the biometric reading to a template of the biometric reading, storing the template of the biometric reading on the biometrically protected device, receiving a password to generate a key, encrypting the template of the biometric reading using the key to provide an encrypted biometric template, deleting the password and key, and uploading the encrypted biometric template to the server for storage.

10. The method of claim 7, wherein the encrypted biometric template uses a password based key derivation function to prompt a user to enter a secret password that is used to generate a key for encrypting the biometric template.

11. The method of claim 1, wherein the encrypted biometric template uses a password based key derivation function to prompt a user to enter a secret password that is used to generate a key for decrypting the encrypted biometric template.

12. A method of authenticating biometric device without prior enrollment of the biometric device, comprising:
one or more processors and memory coupled to the one or more processors, wherein the memory includes computer instructions which when executed by the one or more processors causes the one or more processors to perform the operations of:
receiving a biometric reading;
converting the biometric reading into biometric template data;
comparing the biometric template data with a biometric template locally stored when the biometric template is locally stored on a biometrically protected device that received the biometric reading and authenticating the biometric reading if the biometric template data matches the biometric template locally stored;
obtaining an encrypted biometric template from a server if the biometric template is not locally stored on the biometrically protected device to compare with the biometric template data;
decrypting the encrypted biometric template from the server in response to receiving a password to provide a decrypted biometric template;
storing the decrypted biometric template locally on the biometrically protected device; and
authenticating the biometric reading when the decrypted biometric template matches the biometric template data.

13. The method of claim 12, wherein the method further comprises the step of performing a new enrollment of the biometrically protected device when a biometric template is neither stored locally on the biometrically protected device nor as an encrypted biometric template on the server.

14. The method of claim 13, wherein the step of performing the new enrollment comprises converting the biometric reading to a template of the biometric reading, storing the template of the biometric reading on the biometrically protected device, encrypting the template of the biometric reading to provide an encrypted biometric template, and uploading the encrypted biometric template to the server for storage.

15. The method of claim 13, wherein the step of performing the new enrollment comprises converting the biometric reading to a template of the biometric reading, receiving a password to generate a key, using the key to encrypt the template of the biometric reading to provide an encrypted biometric template, and uploading the encrypted biometric template to the server for storage

16. The method of claim 13, wherein the step of performing the new enrollment comprises converting the biometric reading to a template of the biometric reading, receiving a password to generate a key, using the key to encrypt the template of the biometric reading to provide an encrypted biometric template, deleting the password and key, and uploading the encrypted biometric template to the server for storage at the server.

17. The method of claim 12, wherein the method further comprises the step of performing a new enrollment of the biometrically protected device when a biometric template is neither stored locally on the biometrically protected device nor as an encrypted biometric template on the server by converting the biometric reading to a template of the biometric reading, storing the template of the biometric reading on the biometrically protected device, receiving a password to generate a key, encrypting the template of the biometric reading using the key to provide an encrypted biometric template, deleting the password and key, and uploading the encrypted biometric template to the server for storage at the server.

18. The method of claim 15, wherein the encrypted biometric template uses a password based key derivation function to prompt a user to enter a secret password that is used to generate a key for encrypting the biometric template.

19. The method of claim 12, wherein the encrypted biometric template uses a password based key derivation function to prompt a user to enter a secret password that is used to generate a key for decrypting the encrypted biometric template.

20. A system of authenticating biometric devices without having to re-enroll each new biometric device, comprising:
one or more processors and memory coupled to the one or more processors, wherein the memory includes computer instructions which when executed by the one or more processors causes the one or more processors to perform the operations of:
receiving a biometric reading;
receiving an encrypted biometric template from a server if a biometric template is not locally stored on a biometrically protected device to compare with the biometric reading;
decrypting the encrypted biometric template from the server in response to receiving a password to provide a decrypted biometric template;
storing the decrypted biometric template locally on the biometrically protected device; and
authenticating the biometric reading when the decrypted biometric template matches the biometric reading.

21. A system of authenticating a biometrically protected device without prior enrollment of the biometric protected device when the biometrically protected device receives a biometric reading, converts the biometric reading into biometric template data and fails to find a locally stored biometric template for comparison, the system comprising:
one or more processors and memory coupled to the one or more processors, wherein the memory includes computer instructions which when executed by the one or more processors causes the one or more processors to perform the operations at a server of:
downloading the encrypted biometric template from the server if the biometric template is not locally stored on the biometrically protected device to compare with the biometric template data;
wherein the encrypted biometric template was previously created by performing a new enrollment of the biometrically protected device when a biometric template was neither stored locally on the biometrically protected device nor as an encrypted biometric template on the server.

22. The system of claim 21, the step of performing the new enrollment of the biometrically protected device when the biometric template is neither stored locally on the biometrically protected device nor as an encrypted biometric template on the server by uploading the encrypted biometric template from the biometrically protected device to the server for storage after the biometrically protected device converts the biometric reading to a template of the biometric reading, stores the template of the biometric reading on the biometrically protected device, receives a password to generate a key, encrypts the template of the biometric reading using the key to provide the encrypted biometric template, and deletes the password and key from the biometrically protected device before uploading the encrypted biometric template to the server.
